(19) United States
(12) Patent Application Publication
(10) Pub. No.: US 2010/0125963 A1
(43) Pub. Date: May 27, 2010

(54) MONOFILAMENT COMPRISING HYDROPHILIC AGENT

(75) Inventor: Amy L. Kneidel, Belpre, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/619,088

(22) Filed: Nov. 16, 2009

Related U.S. Application Data
(60) Provisional application No. 61/116,939, filed on Nov. 21, 2008.

(51) Int. Cl. A46D 1/00; B32B 27/02; B32B 27/34; B32B 27/36; A45D 40/26; A46B 11/00

(52) U.S. Cl. 15/207.2; 428/394; 428/395; 132/218; 401/129

(57) ABSTRACT

Disclosed herein are hydrophilic agents that are suitable for treating polyester and polyamide monofilaments. The treated monofilaments disclosed herein can be used in filaments and brush applicators comprising the monofilaments to apply aqueous solutions to surfaces, including applying pharmaceutical and cosmetic applications to the skin.

### FIELD OF THE INVENTION

The present invention describes hydrophilic monofilaments having pick-up, retention, and release properties that render the monofilaments suitable for various aqueous solutions and applications.

### BACKGROUND OF THE INVENTION

Synthetic monofilaments have been used widely for bristles in brushes, such as cosmetics brushes and paintbrushes, for applying liquids to surfaces. However, synthetic monofilaments are not hydrophilic. Modifications have been made to the monofilaments to enable them to pick up liquids, including liquid makeup or paint.

Monofilaments (brush bristles) are commonly flagged, end-polished, crimped, texturized, mixed with natural hair, or assembled in a brush with voids to enable water pickup. U.S. Pat. No. 5,128,208 shows how a monofilament cross-section can be modified to enhance flagging and tipping and thus, improve paint pick up and release.

It has also been shown that the surface of a monofilament can be modified to either have cavities (pores) as disclosed in EP 1 272 070 B1 and 2004/0187893 A1, or convexities and concavities (U.S. Pat. No. 4,381,325) to enable the monofilament to hold a liquid. A common method for creating concavities is chemical tipping using a strong alkali treatment.

A need has arisen for a hydrophilic monofilament for use in pharmaceutical and cosmeceutical applicator brushes. US 2007/0160562 A1 WO2007/143568 A1, the application of a water-based liquid pharmaceutical is critical to the performance and safety of the pharmaceutical. These patent applications describe a method for applying a pharmaceutical to the eyelid along the eyelash line to stimulate the growth of eyelashes. Targeted delivery and the ability to release a specific volume or dosage are desired. The amount of pharmaceutical delivered to the skin must be precise in order to prevent waste of excess that is not delivered to the target, and prevent pharmaceutical from going into the eye. The speed at which the pharmaceutical is adsorbed by the applicator is also important to make the application of the pharmaceutical easier to the user. In addition, the applicator brush bristles must be sterilizable, safe for skin contact, and not react with the pharmaceutical. Also, the bristles must feel soft when they touch the skin.

Previous methods for enabling monofilaments to pick up water-based solutions are not ideal for meeting all of the needs of pharmaceutical applications. For example, modifying the tips of the monofilaments by flagging, end-polishing, or tipping is not sufficient for picking up, retaining, and releasing a droplet of water-based pharmaceutical in a small applicator brush due to the limited surface area at the tip of the brush.

Typically during the production of small diameter monofilaments (<5 mils), the monofilaments are coated with silicone or slip agents to reduce static and improve processability. The problem presented by this coating is that the silicone is hydrophobic. Consequently, such a coating is not favorable for adsorbing water, or for adsorbing water quickly, retaining it, and/or releasing it. Monofilaments are needed that will easily pick up (adsorb quickly) and release water and/or aqueous solutions.

Commercially available hydrophilic coatings have been used to adsorb water-based solutions or wastes in other applications. For example, some textile fiber lubricants are used to improve fiber processing, and are also used in hygienic applications, such as use in diaper top sheets. Lurol PP-912, commercially available from Goulston Technologies, Inc., Monroe, N.C., is used to coat man-made fibers and act as a lubricant to improve fiber processing. Lurol PP-912 is also used as a fiber coating in hygienic applications, such as in diaper top sheets, because it is also hydrophilic and able to adsorb liquid waste. Another coating from Goulston Technologies, Inc. in Monroe, N.C., Lurol PS-9725-NAD has similar properties to Lurol PP-912 and is used for similar hygienic and fiber applications.

The present invention describes a monofilament that meets the needs for pharmaceutical application, such as described in US 2007/0160562 A1 and WO 2007/143568 A1, and other cosmetic or cosmeceutical applications. Disclosed herein are treated monofilaments, having an effective amount of hydrophilic agent to provide a favorable balance of aqueous pick up and release properties, and a coating application process.

### SUMMARY OF THE INVENTION

It is an object of the present invention to provide a treated polymeric monofilament comprising (i) a polymeric monofilament and (ii) an effective amount of a hydrophilic agent, wherein said agent increases aqueous pick-up and aqueous retention of said monofilament.

It is another object of the present invention to provide a treated monofilament that has utility in application of various aqueous media, including cosmetic application, pharmaceutical application, or cosmeceutical application.

### DETAILED DESCRIPTION OF THE INVENTION

Disclosed herein is treated polymeric monofilament comprising (i) a polymeric monofilament and (ii) an effective amount of a hydrophilic agent, wherein said agent increases aqueous pick-up and aqueous retention of said monofilament. The monofilaments disclosed herein provide a balance of aqueous pick-up, retention and release properties that are needed for certain targeted delivery or desired volume of aqueous solutions and applications.

As used herein, “pick-up” means the ability of treated monofilament to uptake water and/or aqueous solution by adsorption onto the monofilament surface. The term also includes the ability of the monofilament to absorb water and/or aqueous solution into a brush comprising treated monofilament.

As used herein “retention” means the ability of treated monofilament to retain a sufficient amount of water and/or aqueous solution on the surface of treated monofilament or a brush comprising treated monofilament.

As used herein ‘release’ means the transfer of water and/or aqueous solution from the treated monofilament to a desired target or surface.

The monofilament of the present invention has utility in application of various aqueous media, including cosmetic application, pharmaceutical application, or cosmeceutical applications. While the use of the terms cosmetic, pharmaceutical, and cosmeceutical are not intended to be limiting, rather, use of the terms is intended to be inclusive of each. Additional applications of treated monofilament disclosed herein also include with aqueous paints, toothbrushes or tooth cleaning solutions, cleaning solutions, or hiding solutions.

By “cosmetic” is meant articles intended to be rubbed, poured, sprinkled, sprayed on, introduced into, or otherwise applied to the human body . . . for cleansing, beautifying, promoting attractiveness, or altering the appearance.

By “pharmaceutical” is meant articles intended for use in the diagnosis, cure, mitigation, treatment, or prevention of disease” and “articles (other than food) intended to affect the structure or any function of the body of man or other animals.

By “cosmeceutical” is meant, cosmetic products that have drug-like benefits. This term is sometimes used in the cosmetic industry. The term “cosmeceutical” also includes an active ingredient in a cosmetically or pharmaceutically acceptable (i.e., suitable for use in a human or other mammal) excipient, carrier, or vehicle. The active ingredient is typically one which has been approved for a non-cosmetic use and has been re-formulated for a new consumer use (e.g., uses a lower concentration of the active ingredient than the approved use).

Typical monofilaments used in cosmetic and pharmaceutical brush applicators are not hydrophilic and do not meet the need for certain types of applications. Cosmetic and pharmaceutical brush applicators are used for aqueous cosmetic or medicinal applications. A monofilament is needed that will increase the hydrophilicity of a monofilament surface. Methods of imparting hydrophilicity include, but are not limited to, coating the monofilament with an effective amount of hydrophilic agent, or combining an effective amount of hydrophilic agent with polymeric resin prior to extruding the filament. In the present invention, the monofilament is treated by applying a coating to its surface.

The hydrophilic coating of the present invention is suitable for use in cosmetic and pharmaceutical applicators for applying aqueous cosmetics or pharmaceuticals because the coating is retained on the monofilament after exposure to aqueous solution. That means the monofilament coating is not compromised when exposed to aqueous solution. In addition the coating, as well as the coated monofilament, are suitable for human skin contact.

It is recognized that a pharmaceutical applicator comprising treated monofilament must have the ability to pick-up (adsorb) a small volume, such as a drop or droplet of an aqueous solution, and, aqueous solution should be easily released from the brush upon contact with the target, or human skin. The pick-up must occur quickly so that (i) there is less chance for the user to introduce variation by lengthening or shortening the pick-up time (ii) more than simple instructions are not needed to achieve the desired pick-up and (iii) there is proper release of the desired volume based on the volume of pick up. It is necessary to quickly pick-up the intended volume amount of the aqueous solution on the treated monofilament, or an applicator brush comprising the treated filament.

The treated monofilament of the present invention demonstrates relative quick aqueous solution pick-up. Once the intended volume of aqueous solution is adsorbed by the treated monofilament, or applicator brush comprising the monofilament, it is necessary to retain the aqueous solution on the monofilament. Retention is necessary to allow for controlled release of the aqueous solution onto the skin or other target. The amount of aqueous solution released from the brush should not be too much or the aqueous solution could run down the skin and come into contact with areas of the skin that are not intended to be treated by the aqueous solution, such as in the eye. Furthermore, the release of aqueous solution from the treated monofilament should also be sufficient such that the aqueous solution will leave the monofilament and make contact with the intended target, or human eyelid or skin (i.e., not leaving the surface or skin dry, or feeling dry).

One specific application for the treated monofilament disclosed herein is for use in applicators for applying a pharmaceutical to the eyelid at the eyelash line for treatment of hypotrichosis of the eyelashes. The treated monofilament disclosed herein meets the unique requirements for this specific application which include 1) the treated monofilament is acceptable for human skin contact, 2) treatment with a hydrophilic agent that is compatible with cosmetic and pharmaceutical products, 3) the surface treatment is a coating that remains on the monofilament surface 4) using coating and monofilament ingredients that are eligible for approval for pharmaceutical and/or cosmetic use, 5) the treated monofilaments readily pick-up the aqueous solutions and/or products readily, and preferably, in less than one second, 6) the treated monofilaments retain and release an adequate amount of pharmaceutical onto the skin, and 7) the treated monofilaments do not release too much pharmaceutical onto the skin which could cause unintended areas of the skin to be exposed to the pharmaceutical (e.g., eyes).

The treated monofilaments disclosed herein are treated by applying an effective amount of hydrophilic agent to the monofilament surface. An effective amount of hydrophilic agent is a quantity necessary to provide desired pick-up, with desired retention, and preferably desired release properties. It is preferable to use the least amount of hydrophilic agent as necessary. The concentration of the hydrophilic agent applied to the monofilament is determined by the concentration as obtained from the source, and is generally not critical so long as the effective amount yields the desired pick-up and release desired. Treated monofilaments disclosed herein have improved aqueous pick-up and release properties that are improved over monofilaments coated with silicone or similar slip agents. The coated monofilaments disclosed herein are useful for applying a variety of aqueous solutions including, but not limited to those used for, cosmetics, medicines, teeth cleaning solutions, household, craft, industrial, fine art and automotive paints, and hiding solutions, such as typographical error correction solutions.

The monofilaments of the present invention are prepared from polymeric materials known in the art. These include (i) polyesters, which includes but is not limited to, polyethylene terephthalate (PET); polytrimethylene terephthalate (PTT) polybutylene terephthalate (PBT), Hytrel® thermoplastic polyester (TPE); and (ii) polyamides, which includes, but is not limited to nylon 6, nylon 6,6, and nylon 6,12.

The monofilaments prepared from polyesters and polyamides disclosed herein, may be modified to enhance the monofilament or make it more appealing to the user, especially for treated monofilament that will be used on human skin. Some modifications are carried out to provide softness to the monofilament. These modifications include adding desired color, tipping, feathering, and creating shaped cross-sections.

Tipping can be achieved mechanically, or chemically. Mechanical tipping can be achieved by passing the monofilament over a rotating grindstone. A common method for tipping a monofilament is a method known as chemical tipping, which is described in U.S. Pat. No. 4,381,325. Where tipping is applied to the monofilaments of the present invention, it is preferable to treat the monofilament with the hydrophilic agent after the tipping process. Such treatment is preferably coating the tipped filament with the hydrophilic agent, as exemplified in the present examples.

Other modifications may be made to the monofilament, including creating shaped cross-sections, such as trilocular or tetralocular, to create feathering for softness and reduced stiffness. Another suitable modification is to prepare hollow monofilament using a suitable spinneret for extrusion, to reduce stiffness. Such modifications as are commonly known in the art, such as described in U.S. Pat. No. 5,128,208 and U.S. Pat. No. 4,279,053, which are incorporated herein by reference.

Useful hydrophilic agents of the present invention are those that are compatible with the selected polymeric material and which will demonstrate hydrophilicity, pick-up, retention and preferably release of aqueous solution, and more preferably a predictable or consistent release of the aqueous solution. Suitable hydrophilic agents include Lurol PS-9725 NAD, and Lurol PP-912, both of which are commercially available from Goulston Technologies, Inc., Monroe, N.C.

It is preferred that the process for treating monofilament results in the coating being applied such that the coating is consistent about the surface of the monofilament.

### Example I

The improvement in aqueous pick-up characteristics of PBT and Nylon 6,12 monofilaments, when treated with a hydrophilic agent, is exemplified in this example. Data is given in Tables I and II.

The monofilaments for Samples A, B, C, D, E, and F were produced using a PBT polyester (Ultradur B4500 supplied by BASF) and extruded using a typical extrusion process for monofilaments. The PBT resin was melted with a black colorant (Pigment Black 7 supplied as a PBT masterbatch (29290-A1) by Americhem) using a twin-screw extruder (43 mm twin-screw extruder manufactured by Berstorff). Monofilaments were extruded using a melt pump (manufactured by Zenith pumps) through a spinneret plate containing 360-0.014″ diameter round capillaries at temperatures of 258° C. The resulting monofilaments were then quenched and drawn to a final diameter of 0.0032″ (0.081 mm). The resulting monofilaments were then relaxed. The relaxing step included a conditioning process which heated the monofilaments to 165° C. for 75 seconds.

Sample A, which had no treatment with hydrophilic agent was wound onto a 10″ diameter spool. The resulting spool contained a filament rope consisting of 360 round monofilaments with 0.081 mm diameter.

Samples B, C, D, and E were also wound onto a 10″ diameter spool with no treatment with hydrophilic agent. The resulting spool contained a filament rope consisting of 360 round monofilaments with 0.081 mm diameter.

For sample B, the 360-strand filament rope was treated by coating the monofilament. The coating was done by unwinding the spool and immersing the filament rope in a dispersion of 0.26% (by weight) Dow Corning® 24 Emulsion in 40 C demineralized water for 30 minutes. Dow Corning® 24 is a 35% Silicone emulsion. The resulting concentration of silicone on the surface of the monofilament was a typical concentration for commercially available monofilaments of this diameter.

For sample C, the 360-strand filament rope was treated by coating the monofilament. The coating was done by unwinding the spool and immersing the filament rope in a dispersion of 0.35% (by weight) Lurol PS-9725 NAD (supplied by Goulston Technologies, Inc.) in 40 C demineralized water for 30 minutes.

For sample D, the 360-strand filament rope was treated by coating the monofilament. The coating was done by unwinding the spool and immersing the filament rope in a dispersion of 0.2% (by weight) Lurol PS-9725 NAD in 40 C demineralized water for 30 minutes.

For sample E, the 360-strand filament rope was treated by coating the monofilament. The coating was done by unwinding the spool and immersing the filament rope in a dispersion of 1.5% (by weight) Lurol PS-9725 NAD in 40 C demineralized water for 30 minutes. After immersion, the coated filaments were allowed to air dry.

Sample F was treated by coating the monofilament. The coating was done using Lurol PS-9725 NAD prior to being wound onto a spool. The Lurol PS-9725 NAD (supplied by Goulston Technologies, Inc.) was dispersed in 40 C demineralized water at 0.15% by weight. The coating was applied by a counter-rotating roll, partially submerged in a bath of the coating. The filament rope was passed over the counter-rotating roll. The coating application was controlled by the speed of the filament rope and the speed of the counter-rotating roll. After the coating was applied, the resulting monofilaments were wound onto a 10″ diameter spool. The resulting spool contained a filament rope consisting of 360 round monofilaments with 0.081 mm diameter and the entire length of filament rope was coated with Lurol PS-9725 NAD.

The aqueous pick-up of the monofilaments in Samples A, B, C, D, E, and F were evaluated using the following procedure. First, 0.070 grams of monofilaments were assembled into a tied bundle. The resulting bundle was approximately 1.5 inch long. Second, the bundle was weighed. Third, 35 microliters of water weighing 0.0345 grams was added to the bundle with a pipette. Fourth, the time for all of the water to soak into the bundle was measured.

Table I shows the improvement in aqueous pick-up of monofilament treated with an effective amount of hydrophilic agent (namely, PBT monofilaments coated with Lurol PS-9725 NAD).

TABLE I
Evaluation of Aqueous Pick-up -
3.2 mil PBT Monofilaments in Bundle

| | | % Coating by | |
|---|---|---|---|
| | | Weight on | Time (sec) to Soak Bundle - |
| Sample | Coating | Monofilament | Avg. of Five Readings |
| A | No Coating | 0 | Did not soak in |
| B | Silicone | 0.101 | 87.4 |
| C | Lurol PS-9725 | 0.022 | <1 |
| | NAD | | |
| D | Lurol PS-9725 | 0.259 | <1 |
| | NAD | | |
| E | Lurol PS-9725 | 1.166 | <1 |
| | NAD | | |
| F | Lurol PS-9725 | 0.069 | <1 |
| | NAD | | |

The monofilaments for Samples G, H, I, J, and K were produced with Nylon 6,12 (Zytel 158 supplied by DuPont) and extruded using a typical extrusion process for monofilaments. The Nylon 6,12 resin was melted using a single-screw extruder (2.5 inch single-screw extruder manufactured by Davis Standard). The monofilaments were extruded using a melt pump (manufactured by Zenith pumps) through a spinneret plate containing 440-0.014″ diameter round capillaries at temperatures of 248° C. The resulting monofilaments were then quenched and drawn to a final diameter of 0.0025″ (0.064 mm). The resulting monofilaments were then relaxed. The relaxing step included a conditioning process which heated the monofilaments to 170° C. for 75 seconds.

Sample G, which had no treatment with hydrophilic agent, was wound onto a 10″ diameter spool. The resulting spool contained a filament rope consisting of 220 round monofilaments with 0.064 mm diameter.

Samples H, I, J, and K were also wound onto a 10″ diameter spool with no treatment with hydrophilic agent. The resulting spool contained a filament rope consisting of 220 round monofilaments with 0.064 mm diameter.

For Sample H, the 220-strand filament rope was treated by coating the monofilament. The coating was done by unwinding the spool and immersing the filament rope in a dispersion of 0.26% (by weight) Dow Corning® 24 Emulsion in 40 C demineralized water for 30 minutes. Dow Corning® 24 is a 35% Silicone emulsion. The resulting concentration of silicone on the surface of the monofilament was a typical concentration for commercially available monofilaments of this diameter.

For Sample I, the 220-strand filament rope was treated by coating the monofilament. The coating was done by unwinding the spool and immersing the filament rope in a dispersion of 0.035% (by weight) Lurol PS-9725 NAD (supplied by Goulston Technologies, Inc.) in 40 C demineralized water for 30 minutes.

For Sample J, the 220-strand filament rope was treated by coating the monofilament. The coating was done by unwinding the spool and immersing the filament rope in a dispersion of 0.2% (by weight) Lurol PS-9725 NAD (supplied by Goulston Technologies, Inc.) in 40 C demineralized water for 30 minutes.

For Sample K, the 220-strand filament rope was treated by coating the monofilament. The coating was done by unwinding the spool and immersing the filament rope in a dispersion of 1.5% (by weight) Lurol PS-9725 NAD (supplied by Goulston Technologies, Inc.) in 40 C demineralized water for 30 minutes. After immersion, the coated monofilaments were allowed to air dry.

The aqueous pick-up of the monofilaments in Samples G, H, I, J, and K were evaluated using the following procedure. First, 0.070 grams of monofilaments were assembled into a tied bundle. The resulting bundle was approximately 1.5 inch long. Second, the bundle was weighed. Third, 35 microliters of water weighing 0.0345 grams was added to the bundle with a pipette. Fourth, the time for all of the water to soak into the bundle was measured.

Table II shows the improvement in aqueous pick-up of monofilament treated with an effective amount of hydrophilic agent (namely, Nylon 6,12 monofilaments coated with Lurol PS-9725 NAD).

TABLE II
Evaluation of Aqueous Pick-up - 2.5 mil
Nylon 6,12 Monofilaments in Bundle

| | | % Coating by | |
|---|---|---|---|
| | | Weight on | Time (sec) to Soak Bundle - |
| Sample | Coating | Monofilament | Avg. of Five Readings |
| G | No Coating | 0 | 21.2 |
| H | Silicone | 0.113 | 3.6 |
| I | Lurol PS-9725 | 0.031 | <1 |
| | NAD | | |
| J | Lurol PS-9725 | 0.229 | <1 |
| | NAD | | |
| K | Lurol PS-9725 | 1.637 | <1 |
| | NAD | | |

The percent (%) coating by weight on the monofilament was measured using the following method. First, an empty, clean aluminum tray was weighed on an analytical balance to four decimal places. Second, 10 grams of coated monofilaments were weighed and added to the aluminum tray. Third, 100 ml of isopropanol or xylene were added to the aluminum tray. Isopropanol was used as the solvent for the Lurol PS-9725 NAD. Xylene was used as the solvent for the silicone. Fourth, the monofilaments were immersed in the solvent for 1 hour. Fifth, the monofilaments were rinsed with the solvent 2-3 times and removed from the aluminum tray. Sixth, the aluminum tray and the solvent were placed in a fume hood to volatilize overnight. Seventh, the aluminum tray with the extracted coating were weighed and the coating percentage was calculated.

### Example II

Samples A-K were prepared as described in Example I.

The ability of monofilaments with various coatings to retain water, based on measured released water, was evaluated using the following procedure. First, 0.070 grams of monofilaments were assembled into a tied bundle. The resulting bundle was approximately 1.5 inch long. Second, the bundle was weighed. Third, 35 microliters of water weighing 0.0345 grams was added to the bundle with a pipette. Fourth, all 0.0345 grams of water were soaked into the monofilament bundle. Fifth, a 1 inch line was marked on the back of a human hand with the wet bundle. Sixth, the bundle was weighed. Seventh, the amount of water released by the bundle was calculated.

Tables III and IV demonstrate water retention based on a measure of the percentage of water released onto a human hand to demonstrate the influence of the coating on the water retention property of the monofilament.

TABLE III
Evaluation of Amount of Water Retention based on Measure
of Water Released by Monofilament Bundles Coated with
Various Coatings - 3.2 mil PBT Monofilaments in Bundle

| | | % Coating by | |
|---|---|---|---|
| | | Weight on | % of Water Released - |
| Sample | Coating | Monofilament | Avg. of Five Readings |
| A | No Coating | 0 | 83 |
| B | Silicone | 0.101 | 63 |
| C | Lurol PS-9725 | 0.022 | 24 |
| | NAD | | |
| D | Lurol PS-9725 | 0.259 | 20 |
| | NAD | | |
| E | Lurol PS-9725 | 1.166 | 20 |
| | NAD | | |
| F | Lurol PS-9725 | 0.069 | 20 |
| | NAD | | |

TABLE IV
Evaluation of Amount of Water Retention based on Measure
of Water Released by Monofilament Bundles Coated with Various
Coatings - 2.5 mil Nylon 6,12 Monofilaments in Bundle

| | | % Coating by | |
|---|---|---|---|
| | | Weight on | % of Water Released - |
| Sample | Coating | Monofilament | Avg. of Five Readings |
| G | No Coating | 0 | 40 |
| H | Silicone | 0.113 | 33 |
| I | Lurol PS-9725 | 0.031 | 22 |
| | NAD | | |
| J | Lurol PS-9725 | 0.229 | 18 |
| | NAD | | |
| K | Lurol PS-9725 | 1.637 | 19 |
| | NAD | | |

What is claimed is:

1. A treated polymeric monofilament comprising (i) a polymeric monofilament and (ii) an effective amount of a hydrophilic agent, wherein said agent increases aqueous pick-up and aqueous retention of said monofilament.

2. The monofilament of claim 1 wherein said hydrophilic agent is suitable for use with cosmetics, pharmaceuticals, cosmeceuticals.

3. The polymeric monofilament of claim 2 wherein said monofilament is treated by coating said monofilament with said hydrophilic agent.

4. The coated monofilament of claim 1 wherein said monofilament has improved aqueous pick-up over silicone-treated monofilament.

5. The monofilament of claim 1 wherein said monofilament comprises a polymer selected from polyester or polyamide.

6. The monofilament of claim 4 wherein said polyester is selected from the group consisting of polyethylene terephthalate (PET); polytrimethylene terephthalate (PTT) polybutylene terephthalate (PBT), and thermoplastic polyester (TPE).

7. The monofilament of claim 4 wherein said polyamide is selected from the group consisting of nylon 6, nylon 6,6, and nylon 6,12.

8. The monofilament of claim 1 or 2 wherein said monofilament is tipped.

9. The monofilament of claim 1 or 2 where said monofilament has shaped cross-section.

10. The monofilament of claim 1, wherein said monofilament is used in a brush or applicator.

11. An article of manufacture comprising the monofilament of claim 1 or 3 wherein said article is a brush or applicator.

12. The article of claim 11 wherein said brush or applicator is capable of use for applying water-based or aqueous cosmetic or medicinal solutions.

13. The article of claim 11 wherein said brush or applicator is capable of use for with water-based paint, hiding solution, or tooth cleaning compositions.

14. The monofilament of claim 1 wherein said coating is suitable for human skin contact.
